(19) United States
(12) Patent Application Publication
(10) Pub. No.: US 2008/0270273 A1
(43) Pub. Date: Oct. 30, 2008

(54) METHOD AND SYSTEM FOR REAL-TIME INVOICE VALIDATION AND RECONCILIATION

(76) Inventors: Sergey Koltunov, Richmond Hill (CA); Guy Dor, Rosh Haayn (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/742,034

(22) Filed: Apr. 30, 2007

(51) Int. Cl. G06Q 10/00

(52) U.S. Cl. 705/34

(57) ABSTRACT

Method and system providing real-time validation and reconciliation of invoice formatting process. Specifically, the validation performed is a set of predefined validation rules that is applied on data stored on databases of the billing environment and on formatted invoice files which is the output of the invoice formatting tool. The validation rules may be applied at every stage of the invoice formatting life cycle. Furthermore a user of the disclosed system may add new validation rules to correspond the business logic that changes from time to time. This is done by using a Graphical User Interface (GUI) that allows the user to define (e.g. by drag-and-drop) the parameters that have to be validated, the type of validation and the type of report required. After defining the new rule, it becomes immediately active and may be used in the billing environment during invoice formatting process as an integrated validation system.

### FIELD OF THE INVENTION

The present invention relates generally to billing systems, and more specifically, to validating the invoice formatting process in billing systems.

### BACKGROUND OF THE INVENTION

The billing process in large service-providing corporations, such as the telecom and finance industries has a well defined life cycle. It includes everything from managing the databases holding the details required for billing, through rating the services, to Formatting the billing data into files that may be presented to the customers as invoices. Like every other complex process, the billing process is prone to errors. These errors may cause severe losses to the corporation (in case the errors are in favor of the customers) and, on the other hand, erode customers trust (in case the errors are consistently in favor of the service-providing corporate).

Therefore, there is a paramount importance in validating the billing process throughout its life cycle. Invoice validation, (aka invoice reconciliation) may be performed at various stages along the invoice formatting process. Specifically, the raw data on the billing system's databases may be checked. Then the formatted data ready for presentation to the customers may be again checked. Finally, a comparison between the formatted data and the raw data may be performed as well.

FIG. 1 is a schematic block diagram showing the general architecture of a billing system according to the prior art. The billing environment 100 comprises an invoice formatting tool 110, with access to a plurality of databases residing on the billing environment 100, such as a reference data database 130 and an application data database 140. These databases hold raw data that may be stored in a plurality of data type formats and data structures. Usually the reference data 130 refers to details and parameters regarding the service types available, pricing modules etc., whereas the application data 140 refers to details and parameters regarding the customers (identification details, personal details etc.). In addition, the billing environment 100 includes a billing module 160 coupled to a rater module 120. The billing module 160, together with the rater module 120 generates rated usage details that are kept in the reference database 130 and the application database 140.

The object of the invoice formatting tool 110 is to retrieve data from the billing environment and to format it so that it may be printed, or otherwise presented as an invoice to the customers. Specifically, the invoice formatting tool 110 generates formatted invoice files 150. These files, which may be in any type of computer readable data format, include all the information required for presenting the invoice to the customer. For example, it may be a Portable Document Format (PDF) file, an Advanced Function printing (AFP) file or a PostScript file for paper printing, a Hypertext Markup Language (HTML) file or Extensible Markup Language (XML) file for presenting the invoice as a Web page on the Internet, an American Standard Code for Information Interchange (ASCII) string for presenting the invoice on a mobile phone and any other file type in any format.

Presently, validation and reconciliation of invoice formatting tools 110 are performed manually by quality assurance (QA) personnel.

FIG. 2 is a flowchart showing the life cycle of an invoice formatting process and how validation is performed according to the prior art. According to the presently available invoice formatting tools, the actual invoice formatting 220 is performed without any validation process. Rather, during the invoice formatting 220, a certain amount of invoices is reproduced (either in paper form or as formatted invoice files 150) for quality assurance purposes. This process is called QA invoicing 210. Subsequently afterwards, the reproduced invoices go through a manual QA validation 230. A typical QA invoicing 210 survey covers approximately 1-5% of the total number of invoices in an invoice cycle (the periodical process of invoice formatting). The validation is performed by manually comparing the details on the printed invoices or the formatted invoice files 150 to corresponding data from other sources and by checking the validity of the details on the invoices in regards to other details on the invoice. Finally, the QA personnel report on errors detected. During the manual validation, a QA personnel may, for example, verify that the subtotal lines of a specific invoice sum up to the grand total line, validate the details of the customers and that the correct format (layout) for the invoice was selected.

Some invoice formatting tools 110 have semi-automated validation ability. In semi-automated validation, QA personnel use a software tool that is functioned to apply predefined validation rules on the reproduced invoices or the formatted invoice files 150. The validation rule is a function that reads certain invoice parameters and checks their validity, either per se or in relation to other invoice parameters. QA personnel (hereinafter referred to as users) may want to change or add a new validation rules from time to time, according to changes in the business logic. Presently, this requires defining a new rule in the business logic language, writing the validation rule in an upper level computer language, compiling, debugging and recompiling the new rule before it can be added to the validation software. This process usually involves full software development and delivery cycle. It should be noted that even semi automated validation methods do not cover the invoice formatting process but only the QA invoicing survey 210.

In addition to the long time-to-market required in adding new validation rules, semi automated validation process (and to a higher extent, manual validation) suffers from many drawbacks. The semi automated validation process is a non-exhaustive validation process (i.e. only a survey of the invoices in every invoice cycle is being checked). It does not perform formatting validation and cannot perform any type of validation of the raw data stored on the databases of the billing environment 100.

Various attempts have been made towards achieving automated validation systems. For example, PCT Patent Application No. WO0048053, which is incorporated by reference in its entirety herein, discloses a system for validation of transactions, in accordance with a predefined set of rules. However, the disclosed system applies the validation rules after the transaction have been made and not during the process. Moreover, the disclosed system is not integrated within the existing software environment; rather it sends files and receives feedback as an external agent.

Therefore, it would be advantageous to have a software tool that performs invoice validation and reconciliation in real-time; may access the raw data required for invoice formatting and validate it; perform an exhaustive validation of all invoices produced; and allow adding new validation rules that may be activated immediately.

### SUMMARY OF THE INVENTION

The present invention addresses the drawbacks of the manual and semi-automated validation process for billing systems. The method and system disclosed provide real-time validation and reconciliation of the invoice formatting process. Specifically, the validation performed is a set of predefined validation rules that is applied on data stored on databases of the hilling environment 100 and on formatted invoice files 150 which is the output of the invoice formatting tool 110. The validation rules may be applied at every stage of the invoice formatting process (aka invoice production life cycle). Furthermore, the user of the disclosed invention may add new validation rules to correspond the business logic that changes from time to time. This is done by using a Graphical User Interface (GUI) that allows the user to define (e.g. by drag-and-drop) the parameters that have to be validated, the type of validation and the type of report required. After defining the new rule, it becomes immediately active and may be used in the billing environment 100.

According to one aspect of the invention the validation is performed over raw data stored in the billing environment. The object of this validation is to trace errors before the formatting of invoices and to collect statistical information regarding a specific invoice cycle.

According to another aspect of the invention, the validation is performed over formatted invoice files produced by the invoice formatting tool. The object of this validation is to trace errors before the printing of the invoices or presenting them to the customers. Furthermore, it may be used to collect statistical information on the invoice formatting process.

According to yet another aspect of the invention the validation is a cross validation performed over data from two sources. For example, information from formatted invoice files is compared to the corresponding data from the databases of the billing environment. The object of this validation is to trace errors in the invoice formatting process.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 (Prior Art) is a schematic block diagram showing the general architecture of a billing system according to the prior art;

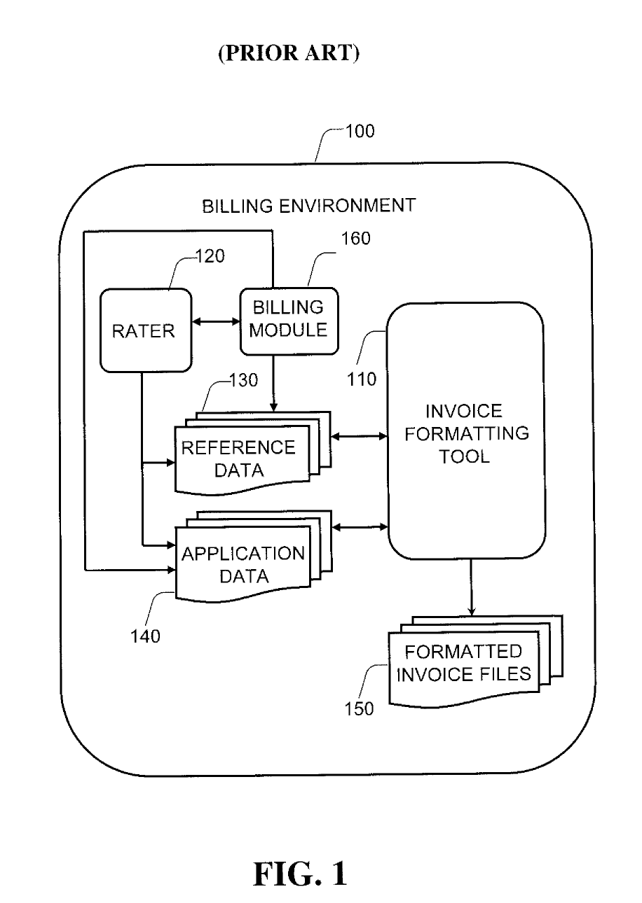

FIG. 2 (Prior Art) is a flowchart showing the life cycle of an invoice formatting process according to the prior art;

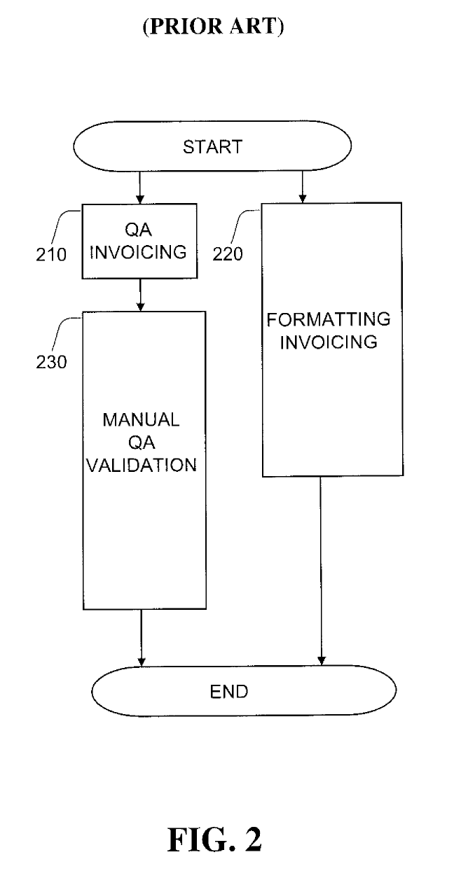

FIG. 3 is a schematic block diagram showing the general architecture of a real-time invoice validation system according to the present invention integrated into an existing billing environment;

FIG. 4 is a flowchart showing the life cycle of an invoice formatting process with a Real-Time invoice validation system according to the present invention;

FIG. 5 is a flowchart showing an aspect of the method according to the present invention;

FIG. 6 is a flowchart showing another aspect of the method according to the present invention;

FIG. 7 is a flowchart showing another aspect of the method according to the present invention; and

FIG. 8 is a flowchart showing yet another aspect of the method according to the present invention;

The drawings together with the description make apparent to those skilled in the art how the invention may be embodied in practice.

Further, where considered appropriate, reference numerals may be repeated among the figures to indicate corresponding or analogous elements. note: no mechanical drawings here

### DETAILED DESCRIPTION OF THE INVENTION

According to all embodiments of the invention, the invention is directed to enhance the performance of billing systems tailored for service-providing corporations. These corporations may include telecommunication companies (e.g. mobile phones companies), financial companies (e.g. banks and insurance companies), invoice consolidation companies (companies that offer the service of consolidating several invoices into one for customer convenience) and any similar service-providing corporation.

In the following description, specific terms are used to describe certain processes and objects relevant to the present invention. The invention will be better understood with the following terms as defined and demonstrated hereinafter:

Source Validation—validation and reconciliation of raw data as stored on databases 130, 140 of the billing environment 100. The raw data may include information regarding the customers, their activity, the rating and billing processes etc. The data may be stored in various formats and various data types and structures. The object of source validation is to check the validity of such data and report errors even before invoice formatting began.

Output Validation—validation and reconciliation of the output of the invoice formatting tool 110. The output is formatted invoices files 115 that hold all the information required for visually presenting the invoice to the customers. The formatted invoices files 115 may hold information as to the visual layout of the invoice. Output validation may report on a missing section in the invoice layout. Another example is detecting inconsistencies such as several sub sums on the invoice that do not sum up to the grand total.

Media Validation—validation and reconciliation of the same information in different data structures, data types and data formats. For example, in the context of source validation, a certain customer's data may be stored in more than one data structure (table). Media validation may verify that the same information may be retrieved from all data structures. Another example in the context of output validation is having a formatted invoice file of two types. One file is a PDF file intended for printing and another is an HTML intended for presenting on a Web page on the Internet. Media Validation may verify that both formats hold the same information

Cross Validation—validation and reconciliation of information from at least two different origins. For example, comparing the grand total of an invoice as retrieved from a formatted invoice file 150 (output) and the same information as stored on the databases 130, 140 of the billing environment 100 (source). Another example is comparing two different formatted invoice files 150 having a special relationship between them, such as bill sharing (e.g. one customer pays for some of the services the other customer used).

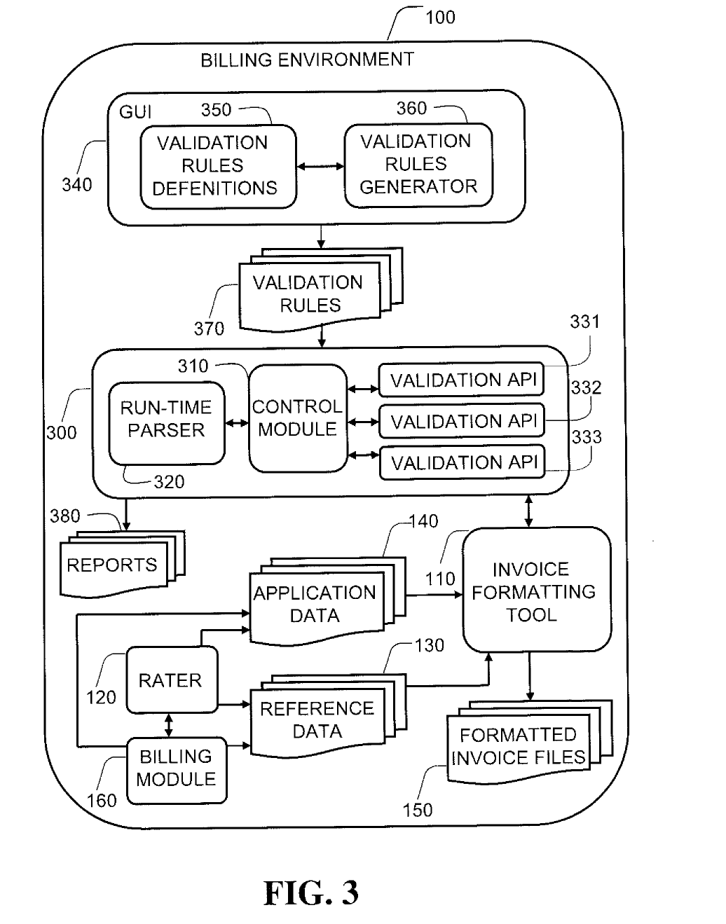

FIG. 3 is a schematic block diagram showing the general architecture of a real-time invoice validation system according to the present invention, integrated into an existing billing environment 100. The real-time invoice validation system comprises a GUT module 340 coupled to a back-end module 300, wherein both modules are embedded into the existing billing environment 100. The GUI module 340 comprises a validation rules generator 360 couples to a library containing validation rules definitions 350. The back-end module 300 comprises a control module 310 coupled to a run-time parser 320 and to a plurality of validation application programmable interfaces (API) 331, 332, 333.

Upon operation, the user is presented with the GUI enabling him or her to add and define a new validation rule. In order to create a new validation rule, the user creates, using the GUI, the envelope of the new validation rule. The rule envelope includes defining the data type, validation type and report type of the new rule. The new definitions are stored on the validation rules library 350, which is used by rules generator 360 to generate validation rule files 370.

Throughout the invoice formatting life cycle, the control module 300 initiates validation processes, in accordance with the user requirements and the validation rules files 370. Specifically, each of the validation API's 331, 332, 333 (which may be of any number) may be invoked by the control module 300. The validation API's 331, 332, 333, may each comprise a set of operations required for performing source validation, output operation, cross validation, cross media and the like, including any combination thereof. The required operations comprise data collecting (data retrieving), usually s executing of the relevant validation rules and finally presenting the billing environment 100 with reports 380. Specifically, the run-time parser 320 is presented with the data collectors holding the relevant data, in accordance to the corresponding API. The run-time parser 320 then executes the relevant validation rules 370 over the relevant data collectors and presents the billing environment 100 (and the invoice formatting tool 110) with relevant report files 380.

According to some embodiments of the invention, the operation of the GUI module 340 and the back-end module 300 are combined into the operation of the billing environment 100, and cooperate with the invoice formatting tool 110.

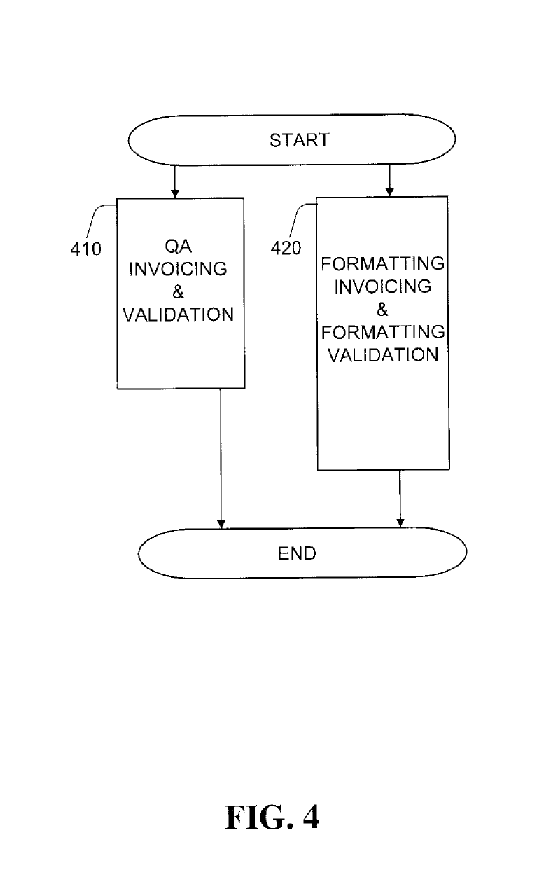

FIG. 4 is a flowchart showing the life cycle of an invoice formatting process with a real-time invoice validation system according to the present invention. The QA invoicing and validation 410 are performed simultaneously. Similarly, formatting invoicing and formatting validation 420 are performed simultaneously. Thus the present invention shortens the validation process, allows a validation of the formatting process as well, and offers an exhaustive invoice formatting (i.e. 100% of the invoices are being validated).

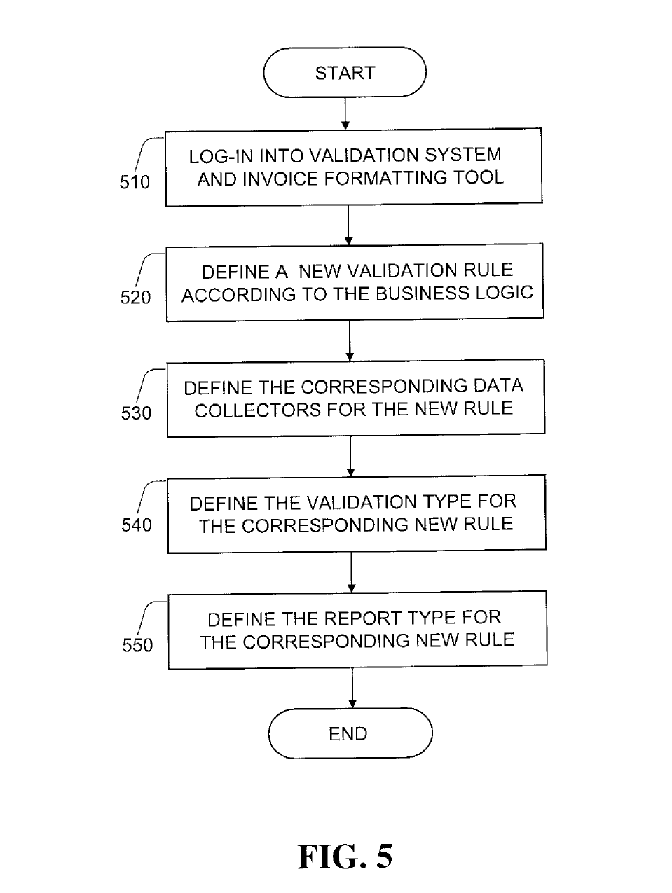

FIG. 5 is a flowchart showing the process of creating a new validation rule according to the present invention. The process starts with logging-into the validating system and the invoice formatting tool 510. Then, the user is defining a new validation rule according to the business logic 520. The rule is being selected (e.g. by drag-and-drop) from a definitions library that hold the description of the validation rules. Then, the user is defining the data collectors for the new rule 530. The data collectors are memory means for retrieving the relevant data from the billing environment 100. Then the user is defining the validation type for the corresponding new rule 540. Finally, the user is defining the report type for the corresponding new rule 550. As described above, the new rule is then presented to the run-time parser 320, which in turn executes and validates the data flow during invoice creation process and finally generate reports, allowing the immediate usage of the new validation rule.

According to some embodiments of the invention, the user may select the severity of the new validation rule. The severity of the rule may be ‘Report’, ‘Fail’ or “Information’. In ‘Report’, the execution of the validation rule will result in a report file. In ‘Fail’, the execution of the validation rule may result in failing the formatting of the erroneous invoice (the actual decision to fail is taken by the invoice formatting tool 110), in addition to reporting. In ‘Information’, the execution of the validation will be skipped and only relevant data is retrieved and reported.

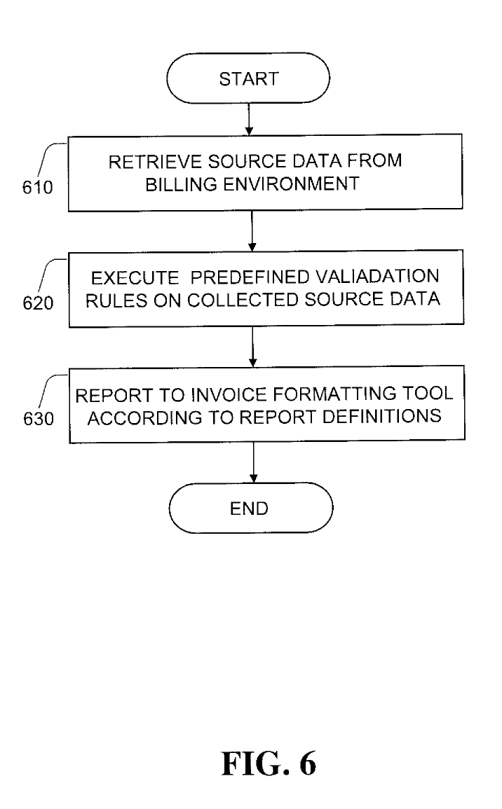

FIG. 6 is a flowchart showing the process of source validation according to the present invention. First, source data is retrieved from the billing environment 100, 610. Then, the predefined validation rules are executed on the collected source data 620. Finally, the invoice formatting tool 110 is being reported according to the report definitions 630. The reports are stored on the billing environment 100 as reports files 390 and the invoice formatting tool 110 receives the reports via the billing environment 100. It should be noted that both validating and reporting is performed by the relevant APIs and the parser in run-time, while the invoice formatting process takes place.

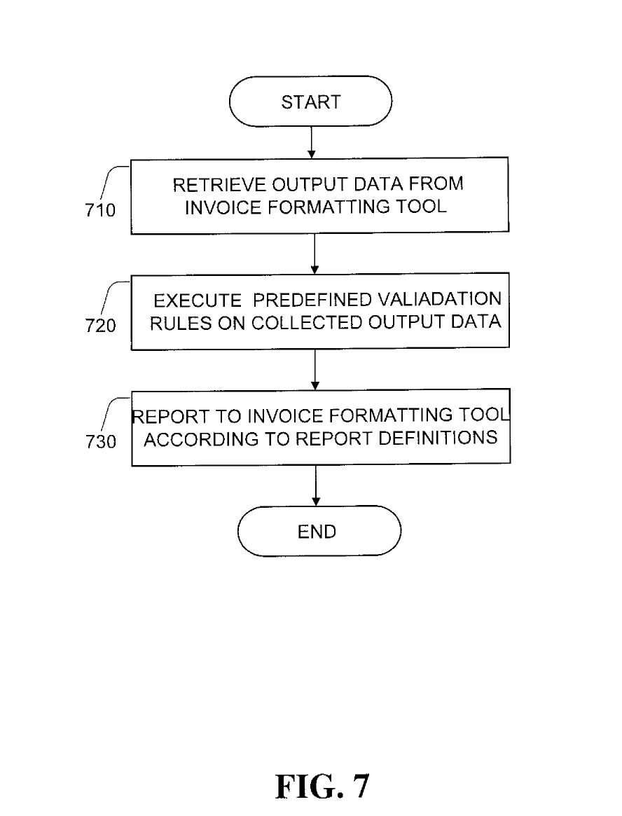

FIG. 7 is a flowchart showing the process of output validation according to the present invention. First, output data is retrieved from the invoice formatting tool 110, 710. Then, the predefined validation rules are executed on the collected output data 720. Finally, the invoice formatting tool 110 is being reported according to the report definitions 730. again, both validating and reporting is performed by the relevant APIs and the parser in run-time, while the invoice formatting process takes place.

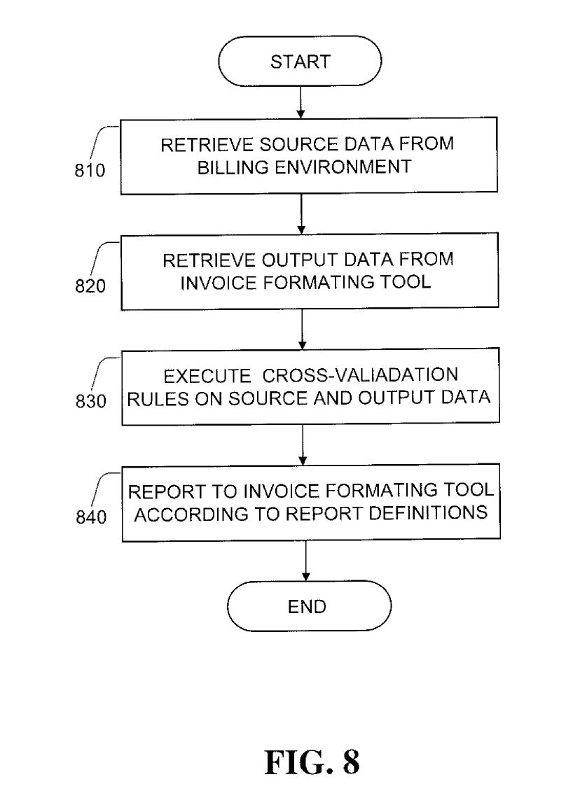

FIG. 8 is a flowchart showing the process of cross validation according to the present invention. First, source data is retrieved from the billing environment 100, 810. Then, output data is retrieved from the invoice formatting tool 110, 820. Then, the predefined cross validation rules are executed on the collected output data 820. Finally, the invoice formatting tool 110 is being reported according to the report definitions 830. Yet again, both validating and reporting is performed by the relevant APIs and the parser in run-time, while the invoice formatting process takes place.

According to some embodiments of the invention, the data retrieval is performed by creating data collectors. The data collectors are data structures that retrieve data from the billing environment 100 and the formatted invoice files 150.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, hut not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for real-time validation and reconciliation of invoices formatting process, wherein said system is integrated within an existing billing environment and cooperates with an invoice formatting tool that produces invoice formatted files, and wherein said system performs the validation during the invoice formatting process, said system comprising:
a back-end module comprising: a control module; coupled to
a run-time parser; and to
a plurality of validation application programmable interfaces;
wherein said control unit invokes at least one validation application programmable interfaces, in accordance with the user requirements and predefined validation rules definitions;
and wherein said at least one validation application programmable interface executes said validation rules using the run time parser on data retrieved from at least two different stages along said invoice formatting process, and present a report to said billing environment.

2. The system according to claim 1, wherein said validation application programmable interface detects relevant differences between data retrieved from one data source and data retrieved from second data source.

3. The system according to claim 2, wherein the validation is performed over raw data stored in the billing environment, and wherein said validation is performed before invoice formatting.

4. The system according to claim 2, wherein the validation is performed over formatted invoice files, and wherein said validation checks at least one of the following: errors in the layout of the invoice, errors in the information on the formatted invoice files.

5. The system according to claim 2, the validation is the validation of the information stored on at least two different data formats.

6. The system according to claim 5, wherein said data formats include at least one of the following: PDF, XML, HTML, ASCII, AFP, PostScript

7. A method for real-time validating and reconciling of an invoices formatting process, wherein said method is integrated into the flow of an existing billing environment, said method comprising the acts of:
collecting data from billing environment, wherein said data is from at least two different stages along the invoice formatting process;
executing predefined validation rules on collected data;
reporting to invoice formatting tool and to reports database according to to report definitions.

8. The method according to claim 7, wherein collecting data from billing environment is preceded by generating a new validation rule using a graphical user interface.

9. The method according to claim 8, wherein said generation of a new validation rule comprising the acts of:
defining data collectors for new validation rule;
defining the validation type for the new validation rule;
defining the report type for the new validation rule.

10. The method according to claim 7, wherein said data comprise reference data and application data, wherein application data comprises data regarding the customers and wherein the reference data comprises service types available and pricing modules.

11. The method according to claim 9, wherein said validation type is at least one of the following: source validation, output validation, media validation.

12. The method according to claim 9, wherein said report type is at least one of the following severities: report, fail, information.

13. The method according to claim 12, wherein severity ‘report’ results in producing a report file to the billing environment.

14. The method according to claim 12, wherein severity ‘fail’ results in providing the invoice formation tool with an indication to fail the processed invoice.

15. The method according to claim 13, wherein severity ‘information’ results in skipping the execution of the validation rule and providing a report based on retrieved information.

16. A system for real-time validation and reconciliation of invoices formatting process, wherein said system is integrated within an existing billing environment and cooperates with an invoice formatting tool that produces invoice formatted files, said system comprising:
means for retrieving data from billing environment;
means for executing predefined validation rules on collected data from at least two different stages along the invoice formatting process;
means for reporting to invoice formatting tool and to the reports file database, according to report definitions.

17. The system according to claim 16, further comprising a graphical user interface (CUI) enabling the user to create a new validation rule, said GUI comprising:
means for defining data collectors for new validation rule;
means for defining the validation type for the new validation rule;
means for defining the report type for the new validation rule.
